(19) United States
(12) Patent Application Publication
(10) Pub. No.: US 2020/0002472 A1
(43) Pub. Date: Jan. 2, 2020

(54) SUSTAINABLE PROCESS FOR PREPARING POLYESTERS HAVING HIGH GLASS TRANSITION TEMPERATURE

(71) Applicants: Fundació Institut Català d'Investigació Química (ICIQ), Tarragona (ES); Institució Catalana de Recerca i Estudis Avançats (ICREA), Barcelona (ES)

(72) Inventors: Arjan Kleij, Torredembarra (ES); Leticia Peña Carrodeguas, Oxford (GB); Maria del Carmen Martín Gandul, Nottingham (GB)

(21) Appl. No.: 16/458,657

(22) Filed: Jul. 1, 2019

Related U.S. Application Data
(60) Provisional application No. 62/693,090, filed on Jul. 2, 2018.

(51) Int. Cl. C08G 63/84; B01J 31/22; C08G 63/42

(52) U.S. Cl. CPC C08G 63/84; B01J 31/2217; C08G 63/42; B01J 2531/842; B01J 2531/004; B01J 2531/0238; B01J 2531/31; B01J 2231/49

(57) ABSTRACT

Aspects of the present invention concern the ring-opening copolymerization (ROCOP) of aromatic anhydrides and epoxides, such as terpene oxides, using sustainable starting materials, as well as the resulting polyester products having an unusually high glass transition temperature and low dispersity.

### CROSS REFERENCE TO RELATED APPLICATION

This application claims the benefit of priority to U.S. Provisional Patent Application No. 62/693,090, filed on Jul. 2, 2018, the disclosure of which is hereby expressly incorporated by reference in its entirety.

### FIELD OF THE INVENTION

The present invention concerns the ring-opening copolymerization (ROCOP) of aromatic anhydrides and epoxides, such as terpene oxides, using sustainable starting materials, as well as the resulting polyester products having an unusually high glass transition temperature and low dispersity.

### BACKGROUND OF THE INVENTION

Synthetic polymers are essential for the production of a range of consumer-based products that focus on improving the quality of life. Due to an increasing demand to prepare such polymers in a sustainable fashion and to make use of renewable monomers derived from biomass, there has been an upsurge in the development of partially to fully bioderived polymers. The ring-opening polymerization (ROP) of cyclic esters in the presence of suitable organic or metal-based initiators produces polyesters such as poly(lactide), and offers an attractive and easy to control polymerization process. However, the diversity in cyclic ester structures and limitations in functional groups present in these polyesters may limit the properties that can be attained through the use of these monomers. Therefore, complementary polyester preparation strategies offer a way to produce polymers with a wider range of properties modulated by the nature of the monomers. The ring-opening copolymerization (ROCOP) of epoxides and cyclic anhydrides has been recognized as a highly versatile route to further extend the properties of polyesters. In particular, the synthesis of aliphatic polyesters prepared through the perfectly alternating ROCOP of aliphatic cyclic esters and epoxides represents an active field of research.

Several groups have catalytically coupled limonene oxide with different cyclic anhydrides to produce polyesters. Jeske et al. (R. C. Jeske, A. M. DiCiccio and G. W. Coates, Journal of the American Chemical Society, 2007, 129, 11330-11331) used an asymmetric [(BDI)ZnOAc] catalyst to couple limonene oxide with both diglycolic anhydride and maleic anhydride to produce polyesters with glass transition temperatures (T_{g}) of 51° C. and 62° C., respectively. Poly(limonene oxide-alt-phthalic anhydride) has been produced in many different studies with glass transition temperatures ranging from 12.3 to 82° C. Nejad et al. (E. H. Nejad, A. Paoniasari, C. G. W. van Melis, C. E. Koning and R. Duchateau, Macromolecules, 2013, 46, 631-637) successfully added chain transfer agents to their LO/PA copolymerization to produce various shorter-chain poly(LO-alt-PA) polyols. These co-polyesters only reach a maximum T_{g} of 82° C., though. Furthermore, they have a polydispersity index of 1.4.

Peña Carrodeguas et al. (Chem. Eur. J., 2015, 21, 6115-6122) disclose the copolymerization of limonene oxide (LO) and CO₂ in the presence of PPNX (X=Cl, Br) co-catalysts and an amino-trisphenolate aluminum complex to produce poly(limonene)carbonate (PLC).

There is thus still a need for alternating co-polyesters based on sustainable starting materials having higher glass transition temperatures and lower dispersities, as well as improved methods for their preparation.

### SUMMARY OF THE INVENTION

In one aspect, the present invention concerns a process for preparing a polyester co-polymer (III) comprising reacting an aromatic anhydride (I) and an epoxide (II):

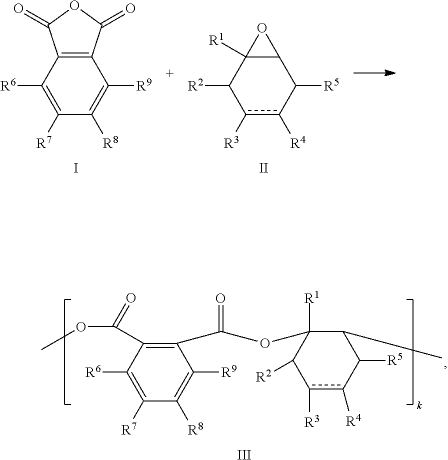

wherein
R¹, R², and R⁵ are independently hydrogen or a C₁ to C₃ alkyl;
R³ is hydrogen;
R⁴ is selected from the group consisting of hydrogen, 1-methyl-ethen-1-yl, and 1-methyl-oxa-cyclopropyl;
or R³ and R⁴ together with the carbon atoms that they are bound to form a three-membered cyclic ring, optionally substituted with one or two methyl groups;
R⁶, R⁷, R⁸, and R⁹ are independently selected from the group consisting of hydrogen, (C₁-C₆)alkyl, halo, (C₁-C₆)alkyloxy, (C₁-C₆)haloalkyl, cyano and nitro; or
one of the pairs R⁶ and R⁷, R⁷ and R⁸, or R⁸ and R⁹ together form an aromatic ring optionally substituted with one or more substituents selected from the group consisting of (C₁-C₆)alkyl, halo, (C₁-C₆)alkyloxy, (C₁-C₆)haloalkyl, cyano and nitro; a dashed line means that a bond is absent or present;
and wherein the reaction is catalysed by a nucleophile selected from the group consisting of nitrogen-containing heterocycles, such as 4-(dimethylamino)pyridine (DMAP), 1,5,7-triazabicyclodecene (TBD) or N-methylimidazole (N-MeIm), tertiary phosphines, such as tris(2,4,6-trimethoxyphenyl)phosphine (TMPP), tricyclohexylphosphine (PCy₃), or triphenylphosphine (PPh₃), a halide salt, such as a bis-triphenylphosphine iminium halide salt, and mixtures thereof together with an amino-triphenolate co-catalyst having the formula:

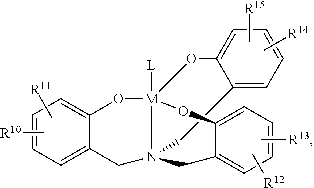

wherein M is Al or Fe, R¹⁰, R¹¹, R¹², R¹³, R¹⁴, and R¹⁵ are independently selected from the group consisting of hydrogen, C₁-C₆ alkyl, such as methyl, C₁-C₆ haloalkyl, C₁-C₆ alkyloxy, halogen, cyano, and nitro, and L is selected from the group consisting of H₂O, tetrahydrofuran, and R—O—R′, R and R′ independently being C₁-C₆ alkyl.

In another aspect, the present invention concerns the polyester resulting from the process of the invention described above. In a further aspect, the invention concerns a polyester co-polymer having a repeating unit of formula IIIa:

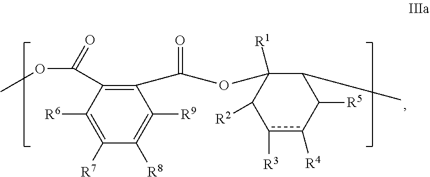

wherein R¹, R², R³, R⁴, R⁵, R⁶, R⁷, R⁸, and R⁹ are as defined above for formula III and wherein a dashed line means that a bond is absent or present, and having a glass transition temperature of at least 90° C. when R⁴ is selected from the group consisting of hydrogen and 1-methyl-ethen-1-yl, or having a glass transition temperature of at least 50° C. when R⁴ is 1-methyl-oxa-cyclopropyl.

In a further aspect, the present invention concerns a process for preparing a polyester co-polymer (VI) comprising reacting an aromatic anhydride (IV) and an epoxide (V):

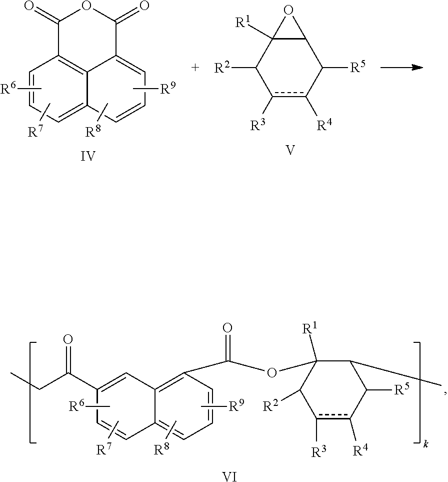

wherein
R¹, R², and R⁵ are independently hydrogen or a C₁ to C₃ alkyl;
R³ is hydrogen;
R⁴ is selected from the group consisting of hydrogen, 1-methyl-ethen-1-yl, and 1-methyl-oxa-cyclopropyl;
or R³ and R⁴ together with the carbon atoms that they are bound to form a three-membered cyclic ring, optionally substituted with one or two methyl groups;
R⁶, R⁷, R⁸, and R⁹ are independently selected from the group consisting of hydrogen, (C₁-C₆)alkyl, halo, (C₁-C₆)alkyloxy, (C₁-C₆)haloalkyl, cyano and nitro; a dashed line means that a bond is absent or present;
and wherein the reaction is catalysed a nucleophile selected from the group consisting of nitrogen-containing heterocycles, such as 4-(dimethylamino)pyridine (DMAP), 1,5,7-triazabicyclodecene (TBD) or N-methylimidazole (N-MeIm), tertiary phosphines, such as tris(2,4,6-trimethoxyphenyl)phosphine (TMPP), tricyclohexylphosphine (PCy₃), or triphenylphosphine (PPh₃), a halide salt, such as a bis-triphenylphosphine iminium halide salt, and mixtures thereof together with an amino-triphenolate co-catalyst having the formula:

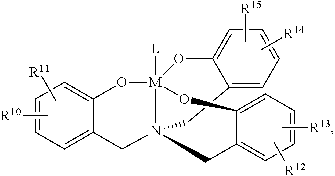

wherein M is Al or Fe, R¹⁰, R¹¹, R¹², R¹³, R¹⁴, and R¹⁵ are independently selected from the group consisting of hydrogen, C₁-C₆ alkyl, such as methyl, C₁-C₆ haloalkyl, C₁-C₆ alkyloxy, halogen, cyano, and nitro, and L is selected from the group consisting of H₂O, tetrahydrofuran, and R—O—R′, R and R′ independently being C₁-C₆ alkyl.

In still a further aspect, the present invention concerns a polyester co-polymer having a repeating unit of formula VIa:

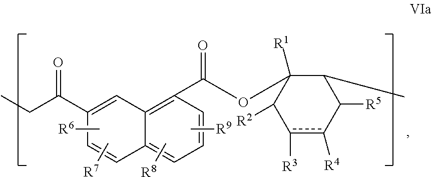

wherein R¹, R², R³, R⁴, R⁵, R⁶, R⁷, R⁸, and R⁹ are as defined above for formula VI and wherein a dashed line means that a bond is absent or present, and having a glass transition temperature of at least 160° C.

### DETAILED DESCRIPTION OF THE INVENTION

### Definitions

M^{Me}

When referring to the amino-triphenolate catalyst

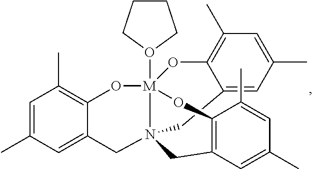

it will be referred to herein also as M^{Me}. In the case of having a central aluminium atom, it is referred to as Al^{Me}. In the case of having a central iron atom, it is referred to as Fe^{Me}.

bis-triphenyiphosphine iminium halide (Ph₃P═N⁺═PPh_{3′}X⁻)

When referring to bis-triphenylphosphine iminium halide, it will be referred to herein also as PPNhal, e.g. in the case of the chloride as PPNCl.

LO, CHDO, CAO, MEO, LDO, and CHO

The meaning of the terms “limonene oxide” (LO), “cyclohexadiene oxide” (CHDO), “carene oxide” (CAO), “menthene oxide” (MEO), “limonene dioxide” (LDO), and “cyclohexane oxide” (CHO) are known to the person skilled in the art. The structures of these compounds, shown without stereochemistry, are:

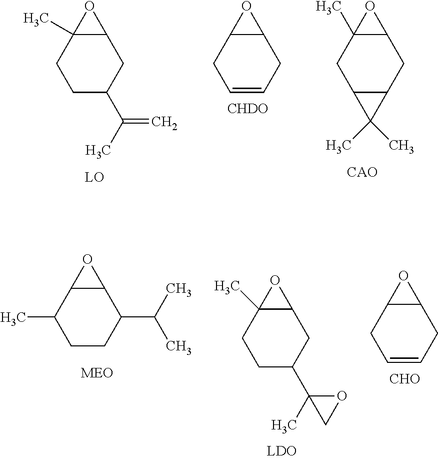

Halide

Herein, the terms “halogen” and “halo” include fluoro, chloro, bromo, and iodo. Accordingly, “halide” includes fluoride, chloride, bromide, and iodide. In particular, chloride, bromide, and iodide are preferred.

Process

In one aspect, the present invention concerns a process for preparing a polyester co-polymer (III) comprising reacting an aromatic anhydride (I) and an epoxide (II):

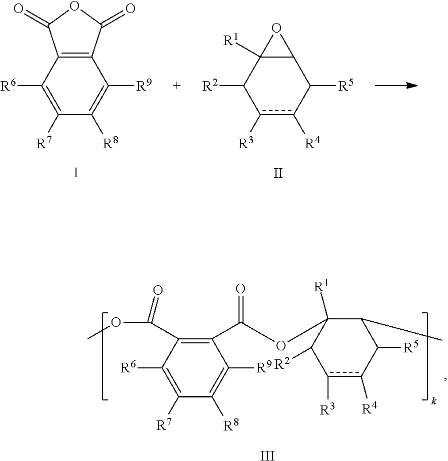

wherein
R¹, R², and R⁵ are independently hydrogen or a C₁ to C₃ alkyl;
R³ is hydrogen;
R⁴ is selected from the group consisting of hydrogen, 1-methyl-ethen-1-yl, and 1-methyl-oxa-cyclopropyl;
or R³ and R⁴ together with the carbon atoms that they are bound to form a three-membered cyclic ring, optionally substituted with one or two methyl groups;
R⁶, R⁷, R⁸, and R⁹ are independently selected from the group consisting of hydrogen, (C₁-C₆)alkyl, halo, (C₁-C₆)alkyloxy, (C₁-C₆)haloalkyl, cyano and nitro; or
one of the pairs R⁶ and R⁷, R⁷ and R⁸, or R⁸ and R⁹ together form an aromatic ring optionally substituted with one or more substituents selected from the group consisting of (C₁-C₆)alkyl, halo, (C₁-C₆)alkyloxy, (C₁-C₆)haloalkyl, cyano and nitro; a dashed line means that a bond is absent or present;
and wherein the reaction is catalysed by a nucleophile selected from the group consisting of nitrogen-containing heterocycles, such as 4-(dimethylamino)pyridine (DMAP), 1,5,7-triazabicyclodecene (TBD) or N-methylimidazole (N-MeIm), tertiary phosphines, such as tris(2,4,6-trimethoxyphenyl)phosphine (TMPP), tricyclohexylphosphine (PCy₃), or triphenylphosphine (PPh₃), a halide salt, such as a bis-triphenylphosphine iminium halide salt, and mixtures thereof together with an amino-triphenolate co-catalyst having the formula:

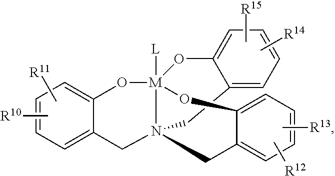

wherein M is Al or Fe, R¹⁰, R¹¹, R¹², R¹³, R¹⁴, and R¹⁵ are independently selected from the group consisting of hydrogen, C₁-C₆ alkyl, such as methyl, C₁-C₆ haloalkyl, C₁-C₆ alkyloxy, halogen, cyano, and nitro, and L is selected from the group consisting of H₂O, tetrahydrofuran, and R—O—R′, R and R′ independently being C₁-C₆ alkyl.

In another aspect, the present invention concerns a process for preparing a polyester co-polymer (VI) comprising reacting an aromatic anhydride (IV) and an epoxide (V):

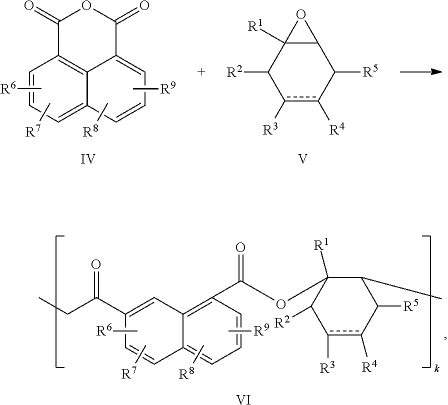

wherein
R¹, R², and R⁵ are independently hydrogen or a C₁ to C₃ alkyl;
R³ is hydrogen;
R⁴ is selected from the group consisting of hydrogen, 1-methyl-ethen-1-yl, and 1-methyl-oxa-cyclopropyl;
or R³ and R⁴ together with the carbon atoms that they are bound to form a three-membered cyclic ring, optionally substituted with one or two methyl groups;
R⁶, R⁷, R⁸, and R⁹ are independently selected from the group consisting of hydrogen, (C₁-C₆)alkyl, halo, (C₁-C₆)alkyloxy, (C₁-C₆)haloalkyl, cyano and nitro; a dashed line means that a bond is absent or present;
and wherein the reaction is catalysed a nucleophile selected from the group consisting of nitrogen-containing heterocycles, such as 4-(dimethylamino)pyridine (DMAP), 1,5,7-triazabicyclodecene (TBD) or N-methylimidazole (N-MeIm), tertiary phosphines, such as tris(2,4,6-trimethoxyphenyl)phosphine (TMPP), tricyclohexylphosphine (PCy₃), or triphenylphosphine (PPh₃), a halide salt, such as a bis-triphenylphosphine iminium halide salt, and mixtures thereof together with an amino-triphenolate co-catalyst having the formula:

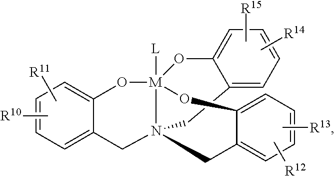

wherein M is Al or Fe, R¹⁰, R¹¹, R¹², R¹³, R¹⁴, and R¹⁵ are independently selected from the group consisting of hydrogen, C₁-C₆ alkyl, such as methyl, C₁-C₆ haloalkyl, C₁-C₆ alkyloxy, halogen, cyano, and nitro, and L is selected from the group consisting of H₂O, tetrahydrofuran, and R—O—R′, R and R′ independently being C₁-C₆ alkyl.

For the co-polymerization in the process according to the present invention, it has been found that it may advantageously be carried out in the presence of 4-(dimethylamino)pyridine and/or a halide salt. It has further been found that different halide catalysts, both organic and inorganic, provide satisfactory results. These include bis-triphenylphosphine iminium halide, such as bis-triphenylphosphine iminium chloride, ammonium halide, alkali metal halide, such as sodium bromide, and halides with β-diiminate complexes. The halide salt is preferably soluble in the reaction solvent. In one embodiment, the halide salt catalyst is bis-triphenylphosphine iminium halide. In a further embodiment, the bis-triphenylphosphine iminium halide is bis-triphenylphosphine iminium chloride.

It has further been found advantageous to carry out the co-polymerization reaction of the invention in the presence of the amino-triphenolate co-catalyst having the formula:

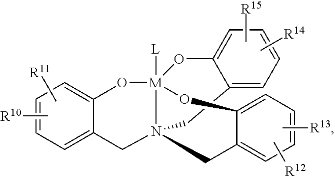

wherein M is Al or Fe, R¹⁰, R¹¹, R¹², R¹³, R¹⁴, and R¹⁵ are independently selected from the group consisting of hydrogen, C₁-C₆ alkyl, such as methyl, C₁-C₆ haloalkyl, C₁-C₆ alkyloxy, halogen, cyano, and nitro, and L is selected from the group consisting of H₂O, tetrahydrofuran, and R—O—R′, R and R′ independently being C₁-C₆ alkyl. In one embodiment, the amino-triphenolate co-catalyst is M^{Me}. In a further embodiment, M is Fe. In another embodiment, M is Al.

The steps of the process according to the present invention may be carried out using various solvents capable of dissolving the reactants of the different steps. Such solvents are typically polar aprotic solvents. Such solvents are apparent to the person skilled in the art and include dichloromethane, chloroform, tetrachloroethane, acetone, toluene, methyl ethyl ketone, acetonitrile, tetrahydrofuran, dioxane, dimethysulfoxide, dimethylformamide and dimethylacetamide.

The aromatic anhydride of formula I may in one embodiment be selected from the group consisting of phthalic anhydride, 1,2-naphthalic anhydride, and 2,3-naphthalic anhydride, optionally substituted with one or more substituents selected from the group consisting of (C₁-C₆)alkyl, halo, (C₁-C₆)alkyloxy, (C₁-C₆)haloalkyl, cyano and nitro. In a further embodiment, the aromatic anhydride of formula I is selected from the group consisting of unsubstituted phthalic anhydride, unsubstituted 1,2-naphthalic anhydride, and unsubstituted 2,3-naphthalic anhydride.

The aromatic anhydride of formula IV may in one embodiment be 1,8-naphthalic anhydride, optionally substituted with one or more substituents selected from the group consisting of (C₁-C₆)alkyl, halo, (C₁-C₆)alkyloxy, (C₁-C₆)haloalkyl, cyano and nitro. In another embodiment, the 1,8-naphthalic anhydride is unsubstituted.

In one embodiment, the epoxides of formulas II and V may independently be a terpene oxide. In a further embodiment, the epoxides of formulas II and V may independently be selected from the group consisting of limonene oxide, cyclohexadiene oxide, cyclohexane oxide, carene oxide, menthene oxide, and limonene dioxide. In still a further embodiment, the epoxide of formulas II and V is limonene oxide. In yet a further embodiment, the terpene oxide of formulas II and V is cis-limonene oxide.

Limonene oxide is a compound of formula II or a compound of formula V wherein

R¹ is methyl;
R², R³ and R⁵ are hydrogen;
R⁴ is 1-methyl-ethen-1-yl;
and the dashed bond represents the absence of a double bond.

Cyclohexadiene oxide is a compound of formula II or a compound of formula V

wherein R¹, R², R³, R⁴ and R⁵ are hydrogen;
and the dashed bond represents the presence of a double bond.

Cyclohexene oxide is a compound of formula II or a compound of formula V

wherein R¹, R², R³, R⁴ and R⁵ are hydrogen;
and the dashed bond represents the absence of a double bond.

Carene oxide is a compound of formula II or a compound of formula V wherein

R¹ is methyl;
R² and R⁵ are hydrogen;
R³ and R⁴ together with the carbon atoms they are bound to form a three-membered cyclic ring substituted with two methyl groups;
and the dashed bond represents the absence of a double bond.

Menthene oxide is a compound of formula II or a compound of formula V wherein

R¹ is hydrogen;
R³ and R⁴ are hydrogen;
R² is methyl;
R⁵ is iso-propyl;
and the dashed bond represents the absence of a double bond.

Limonene dioxide is a compound of formula II or a compound of formula V

wherein R¹ is methyl;
R², R³ and R⁵ are hydrogen;
R⁴ is 1-methyl-oxacyclopropyl;
and the dashed bond represents the absence of a double bond.

The process of the invention is in one embodiment carried out at a temperature in the range from 40 to 80° C., such as in the range from 50 to 80° C.; preferably at a temperature of about 65° C.

### Polyester Co-Polymer Product

As discussed above, the polyester obtained according to the process of the present invention has a higher glass transition temperature than the corresponding polyesters disclosed in the prior art. Accordingly, the process of the present invention leads to a new polyester product having advantageous properties, such as a high glass transition temperature. Thus, one aspect of the present invention concerns the polyesters resulting from the processes of the invention described above. In a further aspect, the invention concerns a polyester co-polymer having a repeating unit of formula IIIa:

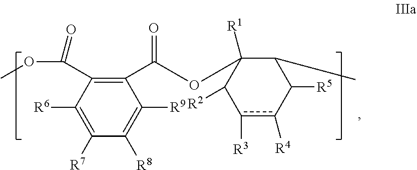

wherein R¹, R², R³, R⁴, R⁵, R⁶, R⁷, R⁸, and R⁹ are as defined above for formula III and wherein a dashed line means that a bond is absent or present, and having a glass transition temperature of at least 90° C. when R⁴ is selected from the group consisting of hydrogen and 1-methyl-ethen-1-yl, or having a glass transition temperature of at least 50° C. when R⁴ is 1-methyl-oxa-cyclopropyl.

In one embodiment, the polyester co-polymer having a repeating unit of formula IIIa has a glass transition temperature of at most 200° C. In another embodiment, the polyester co-polymer having a repeating unit of formula IIIa has a glass transition temperature of at least 100° C. In yet another embodiment, the polyester co-polymer having a repeating unit of formula IIIa has a glass transition temperature of at least 110° C. In still another embodiment, the polyester co-polymer having a repeating unit of formula IIIa has a glass transition temperature of at most 190° C. In a further embodiment, the polyester co-polymer having a repeating unit of formula IIIa has a glass transition temperature of at most 180° C. In still a further embodiment, the polyester co-polymer having a repeating unit of formula IIIa has a glass transition temperature of at most 170° C.

In another aspect, the present invention concerns a polyester co-polymer having a repeating unit of formula VIa:

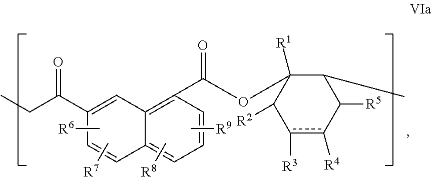

wherein R¹, R², R³, R⁴, R⁵, R⁶, R⁷, R⁸, and R⁹ are as defined above for formula VI and wherein a dashed line means that a bond is absent or present, and having a glass transition temperature of at least 160° C. In one embodiment, the polyester co-polymer having a repeating unit of formula VIa has a glass transition temperature of at most 270° C. In another embodiment, the polyester co-polymer having a repeating unit of formula VIa has a glass transition temperature of at least 170° C. In yet another embodiment, the polyester co-polymer having a repeating unit of formula VIa has a glass transition temperature of at least 180° C. In still another embodiment, the polyester co-polymer having a repeating unit of formula VIa has a glass transition temperature of at most 260° C. In a further embodiment, the polyester co-polymer having a repeating unit of formula VIa has a glass transition temperature of at most 250° C.

In one embodiment, the polyester co-polymer having a repeating unit of formula IIIa is a polyester co-polymer having a repeating unit of formula IIIb:

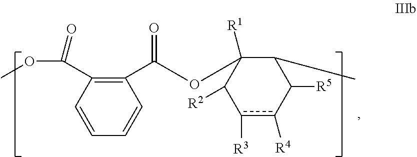

wherein R¹, R², R³, R⁴, and R⁵, are as defined above for formula IIIa and wherein a dashed line means that a bond is absent or present, and having a glass transition temperature of at least 90° C. when R⁴ is selected from the group consisting of hydrogen and 1-methyl-ethen-1-yl, or having a glass transition temperature of at least 50° C. when R⁴ is 1-methyl-oxa-cyclopropyl. In one embodiment, at least one of R¹, R², R³, R⁴, and R⁵ is not hydrogen.

In a further embodiment, the polyester co-polymer having a repeating unit of formula IIIa is a polyester co-polymer having a repeating unit of formula IIIc1:

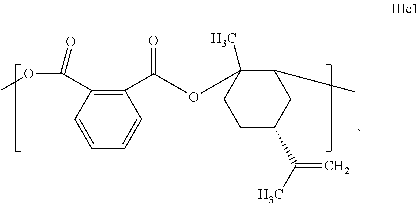

having a glass transition temperature of at least 110° C., such as a glass transition temperature of at least 130° C., e.g. at least 140° C.

In another embodiment, the polyester co-polymer having a repeating unit of formula IIIa is a polyester co-polymer having a repeating unit of formula IIIc2:

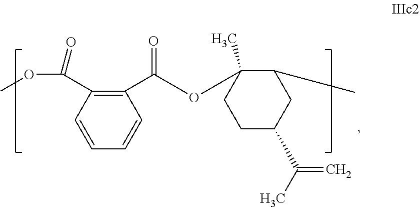

having a glass transition temperature of at least 130° C., e.g. at least 140° C.

In yet a further embodiment, the polyester co-polymer having a repeating unit of formula IIIa is a polyester co-polymer having a repeating unit of formula IIId:

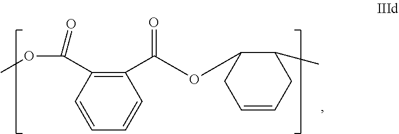

having a glass transition temperature of at least 100° C., such as a glass transition temperature of at least 130° C.

In still a further embodiment, the polyester co-polymer having a repeating unit of formula IIIa is a polyester co-polymer having a repeating unit of formula IIIe:

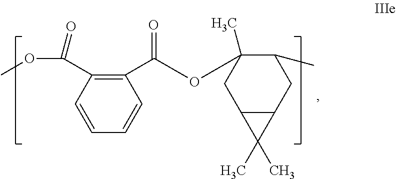

having a glass transition temperature of at least 110° C., such as a glass transition temperature of at least 125° C.

In still another embodiment, the polyester co-polymer having a repeating unit of formula IIIa is a polyester co-polymer having a repeating unit of formula IIIf:

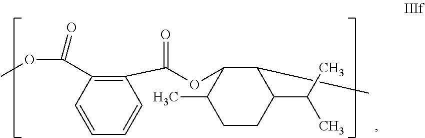

having a glass transition temperature of at least 140° C., such as a glass transition temperature of at least 150° C.

In still another embodiment, the polyester co-polymer having a repeating unit of formula IIIa is a polyester co-polymer having a repeating unit of formula IIIg1, of formula IIg2, of formula IIIg3 or having a mixture of the repeating units IIIg1, IIIg2 and IIIg3:

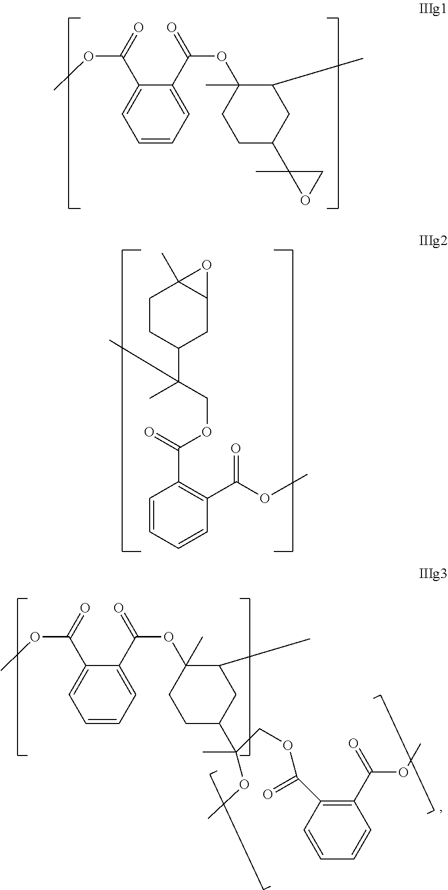

having a glass transition temperature of at least 50° C.

In another embodiment, the polyester co-polymer having a repeating unit of formula VIa is a polyester co-polymer having a repeating unit of formula VIb:

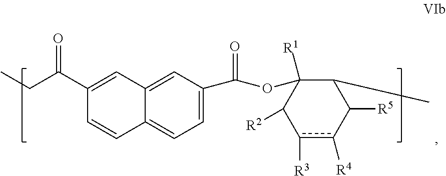

wherein R¹, R², R³, R⁴, and R⁵ are as defined above for formula VIa and wherein a dashed line means that a bond is absent or present, and having a glass transition temperature of at least 160° C.

In still another embodiment, the polyester co-polymer having a repeating unit of formula VIa is a polyester co-polymer having a repeating unit of formula VIc:

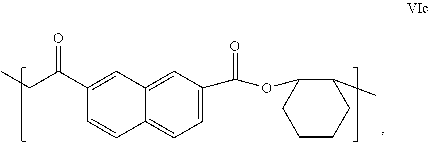

having a glass transition temperature of at least 180° C., such as a glass transition temperature of at least 190° C.

In yet another embodiment, the polyester co-polymer having a repeating unit of formula VIa is a polyester co-polymer having a repeating unit of formula VId:

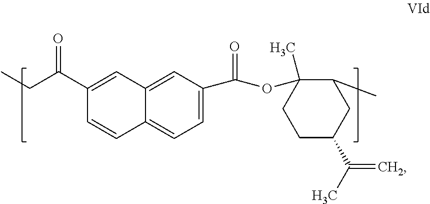

having a glass transition temperature of at least 220° C., such as a glass transition temperature of at least 230° C.

In another embodiment, the polyester co-polymer has a repeating unit of formula IIIa or VIa wherein:

R⁶, R⁷, R⁸ and R⁹ are hydrogen and,
R¹ is methyl;
R², R³ and R⁵ are hydrogen;
R⁴ is 1-methyl-ethen-1-yl;
and the dashed bond represents the absence of a double bond; or
R¹, R², R³, R⁴ and R⁵ are hydrogen;
and the dashed bond represents the presence of a double bond; or
R¹, R², R³, R⁴ and R⁵ are hydrogen;
and the dashed bond represents the absence of a double bond; or
R¹ is methyl;
R² and R⁵ are hydrogen;
R³ and R⁴ together with the carbon atoms they are bound to form a three-membered cyclic ring substituted with two methyl groups;
and the dashed bond represents the absence of a double bond; or
R¹ is hydrogen;
R³ and R⁴ are hydrogen;
R² is methyl;
R⁵ is iso-propyl;
and the dashed bond represents the absence of a double bond; or
R¹ is methyl;
R², R³ and R⁵ are hydrogen;
R⁴ is 1-methyl-oxacyclopropyl;
and the dashed bond represents the absence of a double bond.

In another embodiment, the polyester co-polymer has a repeating unit of formula IIIa or VIa wherein:

R⁶, R⁷, R⁸ and R⁹ are hydrogen and,
R¹ is methyl;
R², R³ and R⁵ are hydrogen;
R⁴ is 1-methyl-ethen-1-yl;
and the dashed bond represents the absence of a double bond; or
R¹, R², R³, R⁴ and R⁵ are hydrogen;
and the dashed bond represents the presence of a double bond; or
R¹, R², R³, R⁴ and R⁵ are hydrogen;
and the dashed bond represents the absence of a double bond; or
R¹ is methyl;
R² and R⁵ are hydrogen;
R³ and R⁴ together with the carbon atoms they are bound to form a three-membered cyclic ring substituted with two methyl groups;
and the dashed bond represents the absence of a double bond; or
R¹ is hydrogen;
R³ and R⁴ are hydrogen;
R² is methyl;
R⁵ is iso-propyl;
and the dashed bond represents the absence of a double bond

### EXAMPLES

### General Conditions.

All water sensitive operations were carried out under nitrogen atmosphere using an Mbraun glovebox, standard vacuum-line and Schlenk techniques. Solvents were purchased from Sigma-Aldrich (HPLC grade) and dried using an MBraun MBSPS800 purification system. All reagents were purchased from commercial suppliers (Aldrich and Acros) and used as received.

NMR spectra were recorded on a Bruker AV-400 spectrometer and referenced to the residual NMR solvent signals.

Glass transition temperatures (T_{g}) were measured under an N₂ atmosphere using a Mettler Toledo equipped, model DSC822e. Samples were weighed into 40 μL aluminium crucibles and subjected to three heating cycles at a heating rate of 5° C./min.

Thermo-gravimetric analyses were recorded under a N₂ atmosphere using Mettler Toledo equipment (model TGA/SDTA851) with a heating rate of 10° C./min.

Gel permeation chromatography (GPC) measurements were performed in tetrahydrofuran at 40° C. at a flow rate of 1 mL·min⁻¹. Samples were analyzed at a concentration of 3 mg·mL⁻¹ after filtration through a 0.45 μm pore-size membrane. The separation was carried out on three polystyrene/divinylbenzene columns from Agilent: PLgel 5 μm MIXED-C, 300×7.5 mm. The setup (Viscotek TDA305) was equipped with a refractive index (RI) detector (λ=670 nm). Mₙ, M_{w} and M_{w}/Mₙ (Ð) were derived from the RI signal by a calibration curve based on polystyrene standards (PS from Polymer Standards Service) for the analysis of the polymers.

Matrix-assisted laser desorption/ionization time-of-flight mass spectrometry (MALDI-TOF) were performed on a BRUKER Autoflex spectrometer using dithranol as a matrix and CF₃COONa as an additive.

### Reagents and Complexes.

The aromatic anhydrides phthalic anhydride (PA) and 1,8-naphthalic anhydride (NA) are commercially available and were used after purification (recrystallization from hot chloroform) and dried under vacuum over 24 h. The epoxide precursors are commercially available. Cis-limonene oxide, cyclohexene oxide and carene oxide [(+)-(1S,3S,4R,6R)-3,4-epoxy-3,7,7-trimethylbicyclo-[4.1.0]heptane]were prepared following literature procedures (Mehrabi, H.; Can. J. Chem. 2009, 87, 1117-1121; Belokon, Y. N.; Chusov, D.; Peregudov, A. S.; Yashkina, L. V.; Timofeeva, G. I.; Maleev, V. I.; North, M.; Kagan, H. B.; Adv. Synth. Catal. 2009, 351, 3157-3167; and Paquette, L. A.; Ross, R. J.; Shi, Y. J.; J. Org. Chem. 1990, 55, 1589-1598) and purified by distillation from CaH₂. Menthene oxide (2-isopropyl-5-methyl-7-oxabicyclo[4.1.0]heptane) was prepared following literature procedures from (−)-menthol (Fiorani, G.; Stuck, M.; Martín, C.; Martínez-Belmonte, M.; Martin, E.; Escudero-Adán, E. C.; Kleij, A. W.; ChemSusChem 2016, 9, 1304-1311) and purified by distillation from CaH₂. LDO (1-methyl-4-(2-methyloxiran-2-yl)-7-oxabicyclo[4.1.0]heptane) was also prepared following literature procedures from the commercially cis and trans limonene oxide mixture and purified by distillation from CaH₂. Commercially available initiators bis(triphenylphosphine)iminium chloride, PPNCl, and 4-dimethylaminopyridine, DMAP, were purified by recrystallization from dichloromethane and dried under vacuum at 40° C. over 24 h. The complexes Fe^{Me} and Al^{Me} were prepared following literature procedures (Whiteoak, C. J.; Martin, E.; Martínez Belmonte, M.; Benet-Buchholz, J.; Kleij, A. W.; Adv. Synth. Catal. 2012, 354, 469-476 and Whiteoak, C. J.; Kielland, N.; Laserna, V.; Castro-Gómez, F.; Martin, E.; Escudero-Galán, E. C.; Bo, C.; Kleij, A. W.; Chem. Eur. J. 2014, 20, 2264-2275).

### Procedure for Polyester Preparation

All reaction mixtures were prepared in a glove box under moisture-free conditions. The binary catalyst (DMAP or halide salt together with the amino-triphenolate co-catalyst) and 1.5 mmol of the corresponding anhydride were placed in an oven-dried 4 mL vial equipped with a magnetic stir bar. The appropriate amount of epoxide and solvent were added and the vial was sealed with a Teflon-lined cap. The reaction mixture was then removed from the glove box and placed in an aluminium heating block preheated at the desired reaction temperature. The reaction mixture was monitored by ¹H NMR spectroscopy. After the ROCOP reaction, the volatiles were removed under vacuum. The crude product was dissolved in a minimal amount of dichloromethane and precipitated with a solution of HCl (1 M) in methanol. This latter procedure was repeated three times and finally the polymer was washed with methanol (three times) and dried under vacuum.

### Example 1—ROCOP Reaction of Phthalic Anhydride and Limonene Oxide

We selected bis(triphenylphosphine)iminium chloride (PPNCl) as the catalyst and the Fe-complex Fe_{Me} as the co-catalyst of the ROCOP of PA and the trisubstituted monomer limonene oxide (commercial cis/trans-LO, cis/trans=40:60) as benchmark reaction. We also employed DMAP (4-dimethylamino-pyridine) as catalyst and Al^{Me} as co-catalyst. The catalysts and co-catalysts were employed with and without a variety of solvents as indicated in Table 1 below. Initial trials were carried out at a relatively low reaction temperature of 65° C. in various solvents (Table 1; entries 1-6) using first Fe^{Me} and DMAP at low loading (0.50 mol %). The copolymerization of LO and PA provided a high quality of poly(PA-alt-LO) under excellent control (>98% ester bonds) and with reasonable molecular weight and low dispersity (Mₙ=10.7 kg/mol; Ð=1.24). Interestingly, the isolated polymer from entry 1 exhibited a high T_{g} value of 135° C. which is significantly higher than the value reported by Nejad et al. (E. H. Nejad, A. Paoniasari, C. G. W. van Melis, C. E. Koning and R. Duchateau, Macromolecules, 2013, 46, 631-637)(82° C.). The use of PPNCl as initiator (entry 2) gave fairly similar results in terms of Mₙ, Ð and T_{g} data, but the reaction was significantly faster.

Reactions under solvent-free conditions were also performed using a larger excess of LO (Table 1, entries 7 and 8; 2 and 5 equiv, respectively). The use of 2 equiv of LO (entry 7) gave full conversion of the PA in 24 h and the molecular weight and dispersity were comparable to the ones obtained in the solution phase process (entry 2) despite the lower T_{g} value (115° C.) measured.

TABLE 1
ROCOP of LO and PA using PPNCI or DMAP and Fe^{Me} (1) or Al^{Me}
(2) as co-catalysts.^{a} Nu stands for nucleophile.

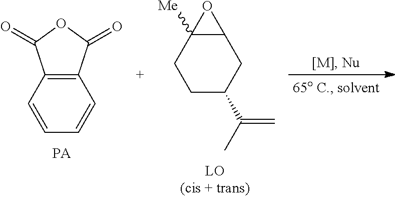

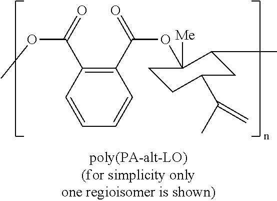

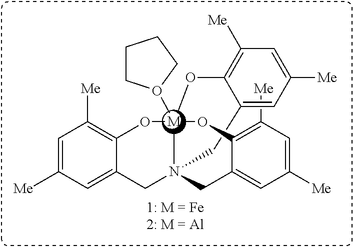

| | [M] | [Nu] | | t | Conv. | Mₙ^{c} | | T_{g} |
|---|---|---|---|---|---|---|---|---|
| Entry | (mol %) | (mol %) | Solv. | (h) | (%)^{b} | (kg/mol) | D^{c,d} | (° C.)^{e} |
| 1 | 1, 0.50 | DMAP, | THF | 48 | 92 | 10.7 | 1.24 | 135 |
| 2 | 1, 0.50 | PPNCI, | THF | 24 | 84 | 10.5 | 1.24 | 131 |
| 3 | 1, 0.50 | PPNCI, | DCM | 24 | 49 | 5.6 | 1.39 | 110 |
| 4 | 1, 0.50 | PPNCI, | Tol | 24 | 46 | 5.6 | 1.28 | 111 |
| 5^{f} | 1, 0.50 | PPNCI, | DMF | 24 | 10 | — | — | — |
| 6^{f} | 1, 0.50 | PPNCI, | ACN | 24 | 25 | — | — | — |
| 7^{g} | 1, 0.50 | PPNCI, | — | 24 | >99 | 9.5 | 1.21 | 115 |
| 8^{h} | 1, 0.50 | PPNCI, | — | 24 | >99 | 5.5 | 1.24 | 95 |
| 9 | 2, 0.50 | DMAP, | THF | 48 | 87 | 4.3 | 1.24 | 104 |
| 10 | 2, 0.50 | PPNCI, | THF | 48 | 71 | 5.5 | 1.21 | 124 |
| 11 | 2, 0.25 | DMAP, | THF | 48 | 62 | 8.0 | 1.24 | 120 |
| 12 | 2, 0.25 | PPNCI, | THF | 48 | 46 | 6.9 | 1.26 | 124 |
| 13^{g} | 1, 0.50 | — | — | 24 | 0 | — | — | — |
| 14^{f,g} | — | PPNCI, | — | 24 | 26 | — | — | — |
| 15 | 1, 0.50 | — | THF | 24 | 0 | — | — | — |
| 16^{f} | — | PPNCI, | THF | 24 | 8 | — | — | — |

^{a}Reaction conditions: 1.5 mmol PA, solvent (0.50 mL), T = 65° C., [PA]:[LO] = 1:1.1.
^{b}Conversion of PA determined by ¹H NMR (CDCl₃); selectivity for the alternating polymer ≥98%, regioselectivity not determined.
^{c}Determined by GPC in THF (30° C.) using polystyrene standards for calibration.
^{d}D = M_{w}/Mₙ.
^{e}Determined by differential scanning calorimetry (DSC), the data refer to the second heating cycle.
^{f}Polymer not isolated.
^{g}[PA]:[LO] = 1:2.
^{h}[PA]:[LO] = 1:5.

### Example 2—ROCOP of Phthalic Anhydride and Various Terpene Oxides

The use of various terpene oxides including cis/trans-LO, cis-LO, carene oxide (CAO), menthene oxide (MEO) and the bifunctional limonene dioxide (LDO) was examined in the ROCOP using PA as the aromatic anhydride. For comparative reasons, some of the results obtained with the cis/trans-LO monomer (Table 1) are included in this example as well (Table 2, entries 1 and 2). While the use of cis/trans limonene oxide (LO) under attractive conditions (65° C., 0.50 mol % of Fe^{Me} and PPNCl) provided appreciable molecular weight poly(PA-alt-LO), the ROCOP of cis-LO (entries 3 and 4) and PA gave a superior grade polyester with Mₙ values of up to 16.4 kg/mol. As observed throughout the copolymerization reactions, the solution phase experiments gave consistently better results in terms of polymer quality. Interestingly, the use of the diastereo-isomerically pure cis-LO monomer resulted in a polyester with an improved and high T_{g} value of 141° C. (entry 3).

Additionally, other epoxide monomers were considered. Carene oxide (CAO), menthene oxide (MEO), cyclohexadiene oxide (CHDO), and limonene dioxide (LDO) were tested. In the case of CHDO (entries 5-6), high molecular weight poly(PA-alt-CHDO) was obtained up to 25 kg/mol (Ð=1.54) in the solution phase polymerization, though the reaction times required for high monomer (PA) conversion were typically longer (40-48 h) compared to the copolymerizations carried out with LO or cis-LO (entries 1-4). The highest T_{g} value (132° C.) for poly(PA-alt-CHDO) is higher than the value reported by Winkler et al. (Winkler, M.; Romain, C.; Meier, M. A. R.; Williams, C. K. Renewable Polycarbonates and Polyesters from 1,4-Cyclohexadiene. Green Chem. 2015, 17, 300-306)(T_{g}=128° C., Mₙ=7.5 kg/mol, Ð=1.17) despite the much higher molecular weights produced by the binary catalyst system according to the present invention.

The conversion of the bulky monomer carene oxide (CAO) required longer reaction times for high PA conversion in solution phase (entry 7). A shorter reaction time and a higher reaction temperature (95° C.) were required when applying bulk copolymerization (entry 8). The solution phase experiment provided slightly better quality poly(PA-alt-CAO) (Mₙ=3.7 kg/mol, Ð=1.39) with a relatively high T_{g} value of 130° C. The use of menthene oxide (MEO) in the ROCOP process provided poly(PA-alt-MEO) grades with molecular weights of up to 12.7 kg/mol (entries 9-11) and a high T_{g} of 165° C. The bifunctional monomer limonene dioxide (LDO; entries 12 and 13) was also copolymerized with PA to afford poly(PA-alt-LDO) at low reaction temperature (45° C.).

TABLE 2
ROCOP of various Terpene Oxides and PA using Fe^{Me} (1)/PPNCI as Binary
Catalyst.^{a}

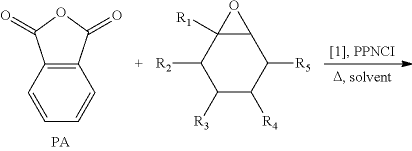

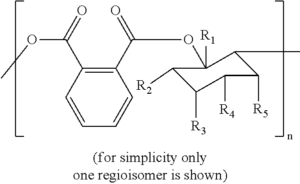

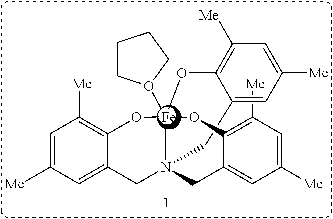

| | |
|---|---|
| 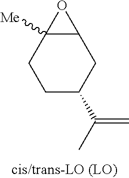 | 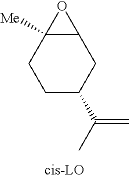 |
| 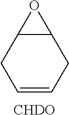 | 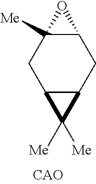 |
| 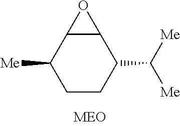 | 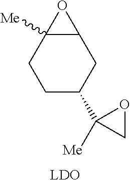 [SMILES: CC12CC[C@@H](C3(C)CO3)CC1O2] |

| | | [1]/PPNCI | | t | Conv. | Mₙ^{c} | | T_{d}¹⁰ | T_{g} |
|---|---|---|---|---|---|---|---|---|---|
| Entry | Sub. | (mol %) | Solv. | (h) | (%)^{b} | (kg/mol) | D^{c,d} | (° C.)^{e} | (° C.)^{f} |
| 1 | LO | 0.50, 0.50 | THF | 24 | 84 | 10.5 | 1.24 | 255 | 131 |
| 2^{g} | LO | 0.50, 0.50 | — | 24 | >99 | 9.5 | 1.21 | — | 115 |
| 3 | cis-LO | 0.50, 0.50 | THF | 24 | >99 | 16.4 | 1.33 | 258 | 141 |
| 4^{g} | cis-LO | 0.50, 0.50 | — | 24 | >99 | 9.2 | 1.44 | — | 129 |
| 5 | CHDO | 0.50, 0.50 | THF | 40 | 85 | 24.9 | 1.54 | 309 | 132 |
| 6 | CHDO | 0.50, 0.50 | — | 48 | >99 | 19.6 | 1.42 | — | 105 |
| 7 | CAO | 0.50, 0.50 | THF | 100 | 79 | 3.7 | 1.39 | 210 | 130 |
| 8^{g,h} | CAO | 0.50, 0.50 | — | 48 | 89 | 3.3 | 1.52 | — | 112 |
| 9 | MEO | 0.50, 0.50 | THF | 24 | 56 | 3.2 | 1.24 | — | 155 |
| 10^{g} | MEO | 0.50, 0.50 | — | 24 | 75 | 5.1 | 1.28 | — | 161 |
| 11^{g} | MEO | 0.30, 0.30 | — | 72 | 75 | 12.7 | 1.20 | 297 | 165 |
| 12ⁱ | LDO | 0.50, 0.50 | THF | 24 | 33 | 8.7 | 1.94 | 287 | 59 |
| 13^{g,i} | LDO | 0.50, 0.50 | — | 24 | 52 | 6.7 | 2.41 | — | 53 |

^{a}Reaction conditions: 1.5 mmol PA, solvent (0.50 mL), T = 65° C. unless stated otherwise, [PA]:[Sub] = 1:1.1.
^{b}Conversion of PA determined by ¹H NMR (CDCl₃); selectivity for the alternating polymer ≥98%, regioselectivity not determined.
^{c}Determined by GPC in THF (30° C.) using polystyrene standards for calibration.
^{d}D = M_{w}/Mₙ.
^{e}From thermogravimetric analysis, data refer to T_{d}¹⁰ values at 10% wt loss.
^{f}Determined by differential scanning calorimetry (DSC), the data refer to the second heating cycle.
^{g}[PA]:[epox] = 1:2.
^{h}Reaction performed at 95° C.
ⁱReaction performed at 45° C.

### Example 3—NMR Analysis of Polyesters

The majority of the polyester products from Table 2 were isolated as compounds with clean and defined NMR features. The polymers based on LO and cis-LO only showed subtle differences in the NMR spectra, but essentially these polymers were free of any detectable ether linkages (see data below). The polyester derived from CHDO (see data below) also showed a well-resolved NMR spectrum in line with a high degree of control over the ROCOP process exerted by the binary catalysts Fe^{Me}/PPNCl. The much lower molecular weight obtained for poly(PA-alt-CAO) (see data below) upon coupling of CAO with PA allows for easy detection of end-groups around 5.0 ppm. The case of MEO/PA copolymerization (see data below) shows primarily two sets of signals in the region for the protons indicated as 1 and 2 that are situated next to the ester linkages.

The ¹H NMR chemical shift values for each of these polymers are the following:

poly(PA-alt-LO) in CDCl₃ (400 MHz) at RT:

δ=7.81-7.48 (m, 4H, CH_{Ar}), 5.57 (s br, 1H, OCH), 4.72 (s br, 2H, C═CH₂), 2.69 (m, 1H, CH), 2.30 (m, 1H, CH₂), 2.17 (m, 1H, CH₂), 1.97-1.79 (m, 2H, CH₂), 1.76-1.96 (m, 6H, CH₃), 1.67 (m, 1H, CH₂), 1.55 (m, 1H, CH₂)

poly(PA-alt-cis LO) in CDCl₃ (400 MHz) at RT:

δ=7.82-7.76 (m, 1H, CH_{Ar}), 7.70-7.64 (m, 1H, CH_{Ar}), 7.62-7.55 (m, 2H, CH_{Ar}), 5.57 (s, 1H, OCH), 4.74 (s, 2H, C═CH₂), 2.72-2.65 (m, 1H, CH), 2.37-2.26 (m, 1H, CH₂), 2.25-2.17 (m, 1H, CH₂), 1.98-1.89 (m, 1H, CH₂), 1.88-1.79 (m, 1H, CH₂), 1.74 (s, 3H, CH₃), 1.73 (s, 3H, CH₃), 1.71-1.65 (m, 1H, CH₂), 1.60-1.50 (m, 1H, CH₂)

poly(PA-alt-CHDO) in CDCl₃ (400 MHz) at RT:

δ=7.67-7.56 (m, 2H, CH_{Ar}), 7.51-7.39 (m, 2H, CH_{Ar}), 5.64 (s br, 2H, CH═CH), 5.44 (s br, 2H, OCH₂), 2.83-2.69 (m, 2H, CH₂), 2.44-2.27 (m, 2H, CH₂) poly(PA-alt-CAO) in CDCl₃ (400 MHz) at RT:

δ=7.82-7.75 (m, 1H, CH_{Ar}), 7.68-7.59 (m, 1H, CH_{Ar}), 7.57-7.38 (m, 2H, CH_{Ar}), 5.45-5.34 (m, 1H, OCH), 3.09-2.78 (m, 1H, CH₂), 2.59-2.31 (m, 1H, CH₂), 2.06-1.84 (m, 1H, CH₂), 1.80-1.72 (m, 1H, CH₃), 1.67-1.61 (m, 2H, CH₃), 1.42-1.33 (m, 1H, CH₂), 1.16-1.11 (m, 1H, CH₃), 1.07-0.98 (m, 5H, CH₃), 0.87-0.76 (m, 1H, CH), 0.73-0.64 (m, 1H, CH)

poly(PA-alt-MEO) in CDCl₃ (400 MHz) at RT:

δ=7.82-7.34 (m, 4H, CH_{Ar}), 5.61-5.04 (m, 2H, OCH), 2.05 (m, 1H, CH), 1.89-1.67 (m, 1H, CH₂), (m, 1H, CH), 1.66-1.28 (m, 2H, CH₂), (m, 1H, CH₂), (m, 1H, CH), 1.14-0.8 (m, 9H, CH₃)

### Example 4—ROCOP of CHO and LO with 1,8-Naphthalic Anhydride

The ROCOP of 1,8-naphthalic anhydride (NA) with both CHO and LO was investigated (Table 3). The first copolymerization experiments were conducted with the monomer CHO (entries 1-4) under catalysis of the binary system Fe^{Me}/PPNCl at 65° C. A solvent was used in these copolymerization experiments due to the low solubility of the NA. The solution phase reactions carried out with CHO and NA were performed in THF, DCM and toluene and compared with the bulk polymerization at an elevated reaction temperature (entry 4, 95° C.). The use of THF as solvent gave high conversion and low dispersity (entry 1; Mₙ=11.4 kg/mol, Ð=1.25). The glass transitions exhibited by these poly(NA-alt-CHO) were high and the T_{g}'s of these polymers reached up to 208° C. The bulk copolymerization (entry 4) provided quantitative NA conversion to the poly(NA-alt-CHO) but gave lower molecular weight and higher dispersity than the one from the solution phase ROCOP of CHO and NA carried out in THF.

The use of LO was also probed and similar reactions conditions as reported in entries 1 and 4 were taken as a starting point towards the preparation of poly(NA-alt-LO) (Table 3, entries 5 and 6). The LO monomer provides moderate NA conversion of around 50% in 72 h, and low molecular weights of up to 2.2 kg/mol with a calculated degree of polymerization (DP) of 7. The analysis of the thermal behavior of these oligomeric macromolecules reveals a high level of rigidity as testified by their T_{g} values of up to 243° C. Thus, by a proper selection of terpene oxide and anhydride monomers the glass transitions of semi-aromatic polyesters can be tuned over a wide range spanning more than 100° C.

TABLE 3
ROCOP of various CHO or cis/trans-LO and 1,8-Naphthalic Anhydide (NA)
using Fe^{Me}/PPNCI as Binary Catalyst.^{a}

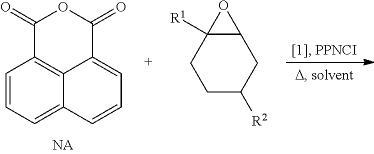

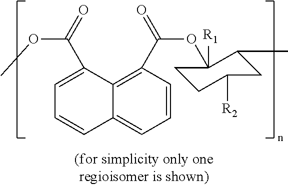

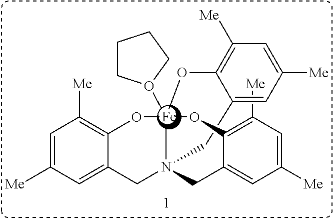

| | |
|---|---|
| 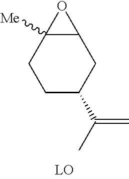 | 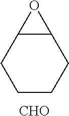 |

| | | | T | t | Conv. | Mₙ^{c} | | T_{d}¹⁰ | T_{g} |
|---|---|---|---|---|---|---|---|---|---|
| Entry | Sub. | Solv. | (° C.) | (h) | (%)^{b} | (kg/mol) | D^{c,d} | (° C.)^{e} | (° C.)^{f} |
| 1 | CHO | THF | 65 | 72 | 79 | 11.4 | 1.25 | 330 | 208 |
| 2 | CHO | DCM | 65 | 72 | >99 | 2.5 | 2.35 | — | 182 |
| 3 | CHO | Tol | 65 | 72 | 31 | 2.3 | 1.81 | — | 190 |
| 4^{g} | CHO | — | 95 | 72 | >99 | 6.9 | 1.71 | — | 182 |
| 5 | LO | THF | 65 | 72 | 50 | 2.2 | 1.36 | 268 | 243 |
| 6^{g} | LO | — | 95 | 72 | 50 | 1.6 | 1.52 | — | 227 |

^{a}Reaction conditions: 1.5 mmol NA, solvent (0.50 mL), [NA]:[Sub] = 1:1.1, [1]: 0.50 mol %, PPNCI: 0.50 mol %.
^{b}Conversion of NA determined by ¹H NMR (CDCl₃); selectivity for the alternating polymer ≥98%, regioselectivity not determined.
^{c}Determined by GPC in THF (30° C.) using polystyrene standards for calibration.
^{d}D = M_{w}/Mₙ.
^{e}From thermogravimetric analysis, data refer to T_{d}¹⁰ values at 10% wt loss.
^{f}Determined by differential scanning calorimetry (DSC), the data refer to the second heating cycle.
^{g}[NA]:[LO] = 1:2.

1. A process for preparing a polyester co-polymer (III) comprising reacting an aromatic anhydride (I) and an epoxide (II): 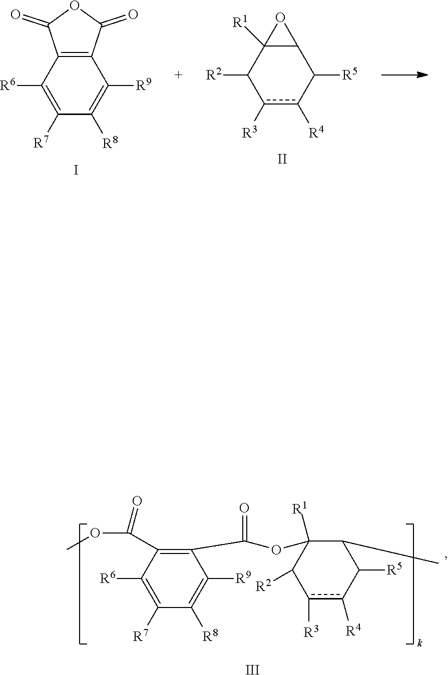
wherein
R¹, R², and R⁵ are independently hydrogen or a C₁ to C₃ alkyl;
R³ is hydrogen;
R⁴ is selected from the group consisting of hydrogen, 1-methyl-ethen-1-yl, and 1-methyl-oxa-cyclopropyl;
or R³ and R⁴ together with the carbon atoms that they are bound to form a three-membered cyclic ring, optionally substituted with one or two methyl groups;
R⁶, R⁷, R⁸, and R⁹ are independently selected from the group consisting of hydrogen, (C₁-C₆)alkyl, halo, (C₁-C₆)alkyloxy, (C₁-C₆)haloalkyl, cyano and nitro; or
one of the pairs R⁶ and R⁷, R⁷ and R⁸, or R⁸ and R⁹ together form an aromatic ring optionally substituted with one or more substituents selected from the group consisting of (C₁-C₆)alkyl, halo, (C₁-C₆)alkyloxy, (C₁-C₆)haloalkyl, cyano and nitro;
a dashed line means that a bond is absent or present;
and wherein the reaction is catalysed by a nucleophile selected from the group consisting of nitrogen-containing heterocycles, such as 4-(dimethylamino)pyridine (DMAP), 1,5,7-triazabicyclodecene (TBD) or N-methylimidazole (N-MeIm), tertiary phosphines, such as tris(2,4,6-trimethoxyphenyl)phosphine (TMPP), tricyclohexylphosphine (PCy₃), or triphenylphosphine (PPh₃), a halide salt, such as a bis-triphenylphosphine iminium halide salt, and mixtures thereof together with an amino-triphenolate co-catalyst having the formula: 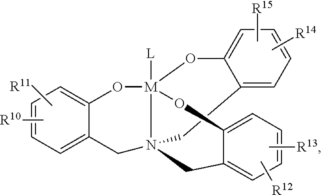
wherein M is Al or Fe, R¹⁰, R¹¹, R¹², R¹³, R¹⁴, and R¹⁵ are independently selected from the group consisting of hydrogen, C₁-C₆ alkyl, such as methyl, C₁-C₆ haloalkyl, C₁-C₆ alkyloxy, halogen, cyano, and nitro, and L is selected from the group consisting of H₂O, tetrahydrofuran, and R—O—R′, R and R′ independently being C₁-C₆ alkyl.

2. The process according to claim 1, wherein the reaction is catalysed by DMAP, a halide salt, or mixture thereof together with an amino-triphenolate co-catalyst having the formula: 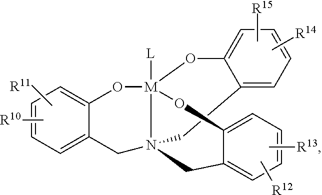
wherein M is Al or Fe, R¹⁰, R¹¹, R¹², R¹³, R¹⁴, and R¹⁵ are independently selected from the group consisting of hydrogen, C₁-C₆ alkyl, such as methyl, C₁-C₆ haloalkyl, C₁-C₆ alkyloxy, halogen, cyano, and nitro, and L is selected from the group consisting of H₂O, tetrahydrofuran, and R—O—R′, R and R′ independently being C₁-C₆ alkyl.

3. The process according to claim 1, wherein the nucleophile catalyst is a halide salt.

4. The process according to claim 1, wherein the nucleophile catalyst is a bis-triphenylphosphine iminium halide salt.

5. The process according to claim 1, wherein the amino-triphenolate co-catalyst is: 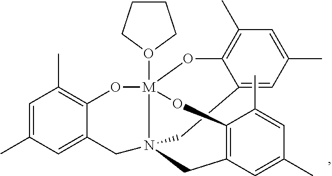
wherein M is Al or Fe,

6. The process according to claim 1, wherein M is Fe.

7. The process according to claim 1, wherein the aromatic anhydride (I) is selected from the group consisting of phthalic anhydride, 1,2-naphthalic anhydride, and 2,3-naphthalic anhydride, optionally substituted with one or more substituents selected from the group consisting of (C₁-C₆)alkyl, halo, (C₁-C₆)alkyloxy, (C₁-C₆)haloalkyl, cyano and nitro.

8. The process according to claim 7, wherein the aromatic anhydride (I) is unsubstituted.

9. The process according to claim 1, wherein the epoxide (II) is a terpene oxide.

10. The process according to claim 1, wherein the epoxide (II) is selected from the group consisting of limonene oxide, cyclohexadiene oxide, cyclohexene oxide, carene oxide, menthene oxide, and limonene dioxide.

11. The process according to claim 10, wherein the epoxide (II) is limonene oxide or menthene oxide.

12. A polyester co-polymer having a repeating unit of formula IIIa: 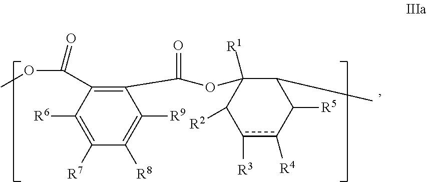
wherein R¹, R², R³, R⁴, R⁵, R⁶, R⁷, R⁸, and R⁹ are as defined in claim 1 and wherein a dashed line means that a bond is absent or present, and having a glass transition temperature of at least 90° C. when R⁴ is selected from the group consisting of hydrogen and 1-methyl-ethen-1-yl, or having a glass transition temperature of at least 50° C. when R⁴ is 1-methyl-oxa-cyclopropyl.

13. The polyester co-polymer according to claim 11 having a glass transition temperature of no more than 170° C.

14. A process for preparing a polyester co-polymer (VI) comprising reacting an aromatic anhydride (IV) and an epoxide (V): 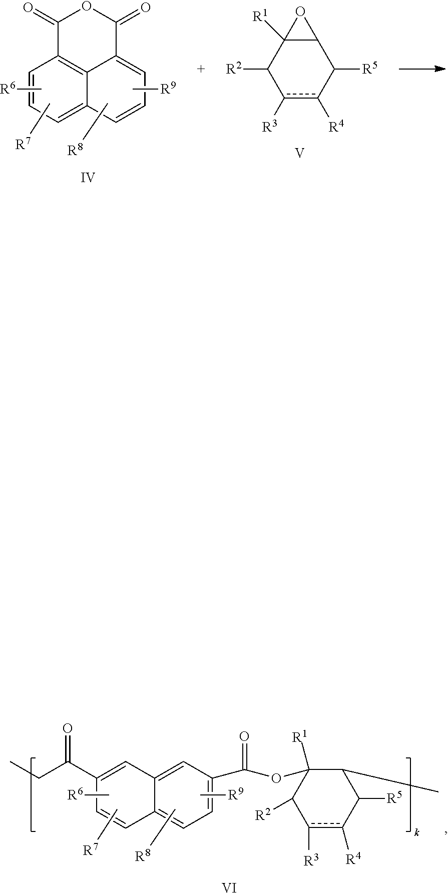
wherein
R¹, R², and R⁵ are independently hydrogen or a C₁ to C₃ alkyl;
R³ is hydrogen;
R⁴ is selected from the group consisting of hydrogen, 1-methyl-ethen-1-yl, and 1-methyl-oxa-cyclopropyl;
or R³ and R⁴ together with the carbon atoms that they are bound to form a three-membered cyclic ring, optionally substituted with one or two methyl groups;
R⁶, R⁷, R⁸, and R⁹ are independently selected from the group consisting of hydrogen, (C₁-C₆)alkyl, halo, (C₁-C₆)alkyloxy, (C₁-C₆)haloalkyl, cyano and nitro;
a dashed line means that a bond is absent or present;
and wherein the reaction is catalysed by a nucleophile selected from the group consisting of nitrogen-containing heterocycles, such as 4-(dimethylamino)pyridine (DMAP), 1,5,7-triazabicyclodecene (TBD) or N-methylimidazole (N-MeIm), tertiary phosphines, such as tris(2,4,6-trimethoxyphenyl)phosphine (TMPP), tricyclohexylphosphine (PCy₃), or triphenylphosphine (PPh₃), a halide salt, such as a bis-triphenylphosphine iminium halide salt, and mixtures thereof together with an amino-triphenolate co-catalyst having the formula: 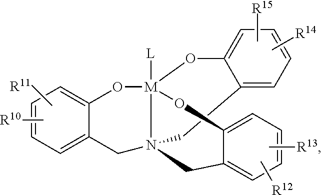
wherein M is Al or Fe, R¹⁰, R¹¹, R¹², R¹³, R¹⁴, and R¹⁵ are independently selected from the group consisting of hydrogen, C₁-C₆ alkyl, such as methyl, C₁-C₆ haloalkyl, C₁-C₆ alkyloxy, halogen, cyano, and nitro, and L is selected from the group consisting of H₂O, tetrahydrofuran, and R—O—R′, R and R′ independently being C₁-C₆ alkyl.

15. The process according to claim 14, wherein the reaction is catalysed by DMAP, a halide salt, or a mixture thereof together with an amino-triphenolate co-catalyst having the formula: 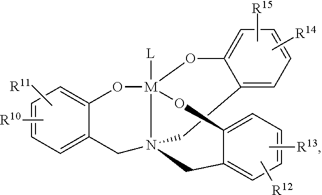
wherein M is Al or Fe, R¹⁰, R¹¹, R¹², R¹³, R¹⁴, and R¹⁵ are independently selected from the group consisting of hydrogen, C₁-C₆ alkyl, such as methyl, C₁-C₆ haloalkyl, C₁-C₆ alkyloxy, halogen, cyano, and nitro, and L is selected from the group consisting of H₂O, tetrahydrofuran, and R—O—R′, R and R′ independently being C₁-C₆ alkyl.

16. The process according to claim 14, wherein the nucleophile catalyst is a halide salt.

17. The process according to claim 14, wherein the nucleophile catalyst is a bis-triphenylphosphine iminium halide salt.

18. The process according to claim 14, wherein the amino-triphenolate co-catalyst is: 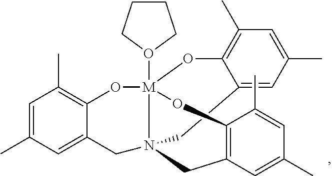
wherein M is Al or Fe,

19. The process according to claim 14, wherein M is Fe.

20. The process according to claim 14, wherein the aromatic anhydride (IV) is 1,8-naphthalic anhydride, optionally substituted with one or more substituents selected from the group consisting of (C₁-C₆)alkyl, halo, (C₁-C₆)alkyloxy, (C₁-C₆)haloalkyl, cyano and nitro.

21. The process according to claim 20, wherein the 1,8-naphthalic anhydride is unsubstituted.

22. The process according to claim 1, wherein the epoxide (V) is a terpene oxide.

23. The process according to claim 14, wherein the epoxide (V) is selected from the group consisting of limonene oxide, cyclohexadiene oxide, cyclohexene oxide, carene oxide, menthene oxide, and limonene dioxide.

24. The process according to claim 23, wherein the epoxide (V) is limonene oxide.

25. A polyester co-polymer having a repeating unit of formula VIa: 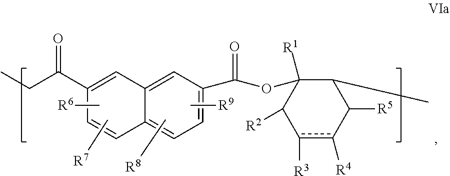
wherein R¹, R², R³, R⁴, R⁵, R⁶, R⁷, R⁸, and R⁹ are as defined in claim 1 and wherein a dashed line means that a bond is absent or present, and having a glass transition temperature of at least 160° C.

26. The polyester co-polymer according to claim 25 having a glass transition temperature of no more than 270° C.
